(19) United States
(12) Patent Application Publication
(10) Pub. No.: US 2013/0270207 A1
(43) Pub. Date: Oct. 17, 2013

(54) RACK WITH DETACHABLE BEAM

(71) Applicant: I-CHEN WANG, Taipei City (TW)

(72) Inventor: I-CHEN WANG, Taipei City (TW)

(21) Appl. No.: 13/447,310

(22) Filed: Apr. 16, 2012

(51) Int. Cl. F16M 13/00

(52) U.S. Cl. 211/123

(57) ABSTRACT

The rack contains at least a column member and at least a beam. The column member contains a support element with at least a vertical chamber. The chamber has an upper section, an enlarged middle section, and a lower section sequentially in this order. The width of the lower section is smaller than the width of the enlarged middle section, but larger than the width of the upper section. The width of the beam is equal to the width of the lower section and the thickness of the beam is smaller than the width of the upper section. The beam is dropped into the chamber by its smaller thickness, turned for an angle in the enlarged middle section, and rested reliably in the lower section.

### TECHNICAL FIELD OF THE INVENTION

The present invention is generally related to wall-mounted or floor standing racks having beams for hanging objects, and more particular to a rack whose beams are detachable.

### DESCRIPTION OF THE PRIOR ART

A towel or cloth rack has a number of beams for hanging objects. For a metallic rack, the beams usually are welded or are riveted or fastened by bolts to the rack. However, the cold metallic feel may not be as appealing as wooden racks. And there are wooden racks whose assembly does not require any metallic nails and screws to achieve even higher appeal.

FIG. 5 depicts a conventional rack A having a circular groove A1 and a hanging beam B detachably mounted in the groove A1. Usually, the hanging beam B and the groove A1 do not match each other tightly and therefore the hanging beam B often breaks loose from the groove A1.

### SUMMARY OF THE INVENTION

Therefore, a novel rack is provided herein whose beams can be quickly installed with superior reliability without worrying about the breaking-loose problem.

The gist of the present invention is that a specifically shaped chamber is configured on a support element of the rack's column member so that a beam can be quickly dropped into and locked to the support element.

Specifically, the rack contains at least a column member and at least a beam. The column member contains a support element with at least a vertical chamber. The chamber has an upper section, an enlarged middle section, and a lower section sequentially in this order. The width of the lower section is smaller than the width of the enlarged middle section, but larger than the width of the upper section. The width of the beam is equal to the width of the lower section and the thickness of the beam is smaller than the width of the upper section. The beam is dropped into the chamber by its smaller thickness, turned for an angle in the enlarged middle section, and rested reliably in the lower section.

To turn the beam smoothly in the enlarged middle section, the walls of the middle section are curved.

A lower face of the beam is optionally configured with a notch so that, when the beam is assembled to the column member, the beam is tightly and reliably positioned on the column member by the notch's engaging the lower section of the chamber.

The support element can optionally contain an upper support element and a lower support element stacked vertically. The chamber is configured in the upper support element with the lower section sealed by the lower support element.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a column member of a rack according to a first embodiment of the present invention.

FIGS. 2A˜2D are schematic diagrams showing how a beam is assembled to the column member of FIG. 1 according to the first embodiment of the present invention.

FIGS. 3A—3C are perspective diagrams showing how a beam is assembled to two column members according to a second embodiment of the present invention.

FIG. 4 is a perspective diagram showing how a ring is assembled to a column member according to a third embodiment of the present invention.

FIG. 5 is a schematic diagram showing a conventional rack.

FIGS. 6 and 7 are perspective diagrams showing a rack according to a fourth embodiment of the present invention when the rack is unfolded with multiple beams installed and when the beams are removed and the rack is collapsed, respectively.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and an of the elements described without departing from the scope of the invention as set forth in the appended claims.

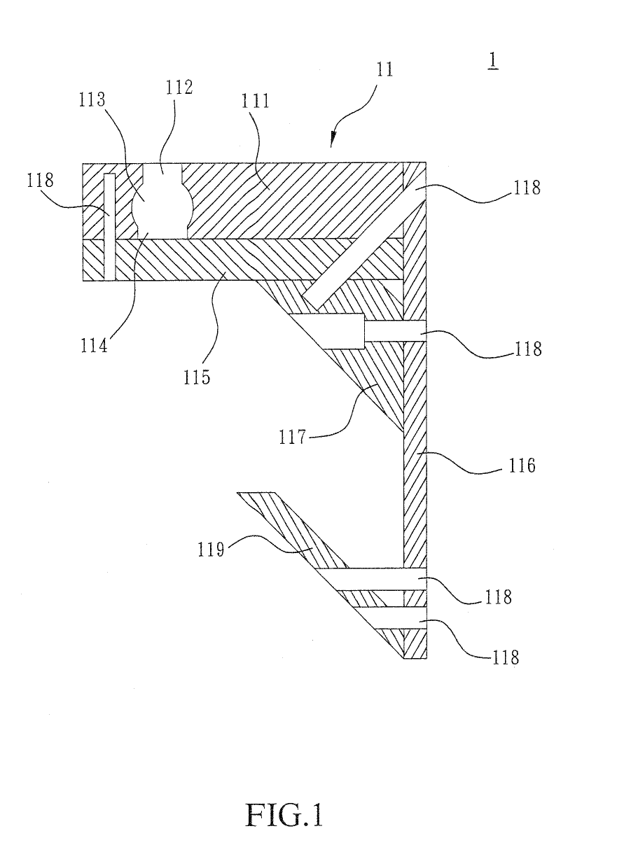

As shown in FIG. 1, a rack 1 according to a first embodiment of the present invention, preferably made of wood or bamboo, contains at least a column member 11 and at least a rectangular beam 12. The column member 11 contains an upper support element 111, a lower support element 115, a base element 116, and at least a reinforcement element 117. The upper and lower support elements 111 and 115 are stacked vertically and joined together by at least a pin 118. The base element 116 is for mounting to a wall. The stacked upper and lower support elements 116 and 117 are joined perpendicularly to the base element 116 by a number of pins 118 running diagonally. At least a triangular reinforcement element 117 is diagonally positioned between the vertical base element 116 and the lateral lower support element 117 by at least an additional pin 118. An additional hook 119 can be optionally extended slantwise from the base element 116 and joined to the base element 116 by some lateral pins 118. A groove is formed by forming a vertical through chamber through the upper support element 111 with an upper section 112, a lower section 114, and an enlarged middle section 113, and by sealing the lower section 114 by the lower support element 115.

The beam 12 is positioned laterally between two column members 11. The width of the beam 12 is substantially equal to the width of the lower section 114 and the thickness of the beam 12 is smaller than the width of the upper section 112.

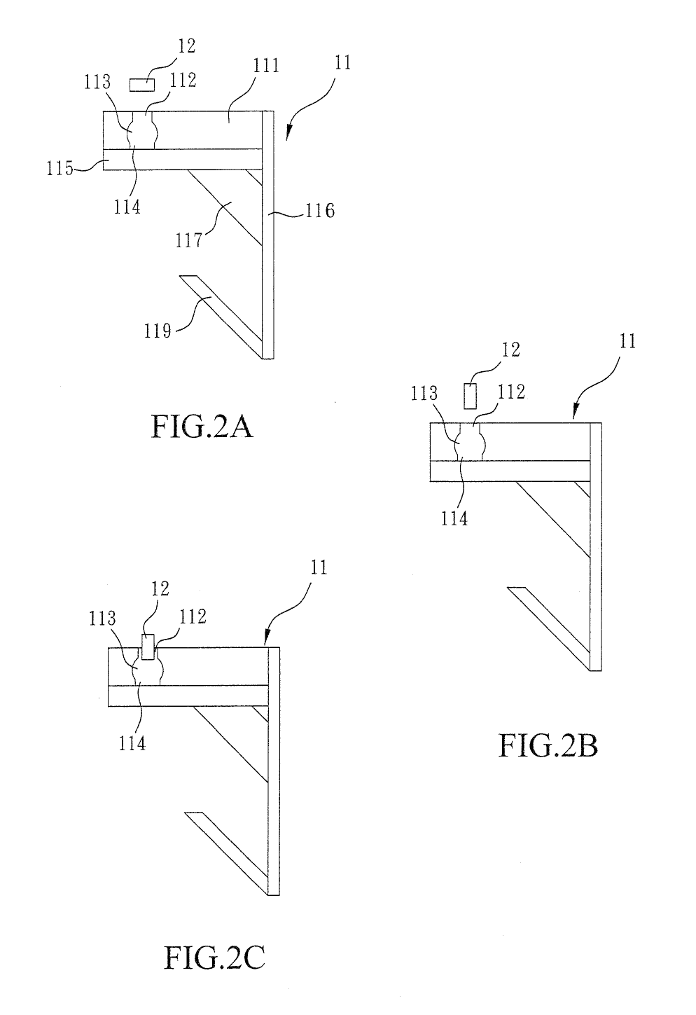

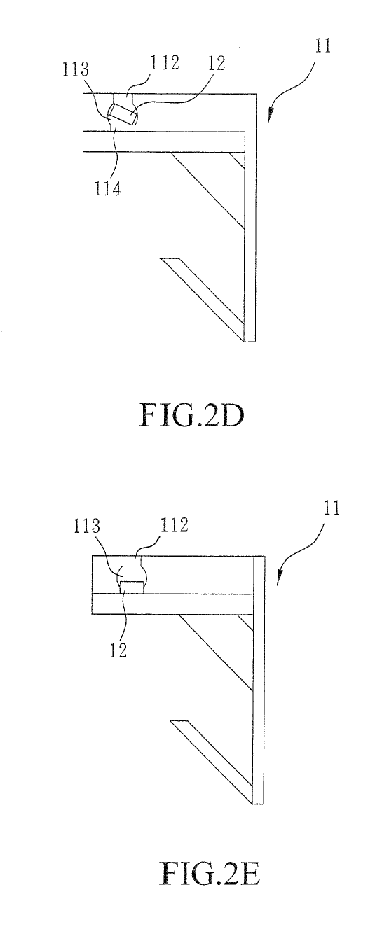

As shown in FIGS. 2A˜2E, to configure the beam 12 on the column members 11, the beam 12 is first turned so that its thickness dimension faces the upper section 112 and as such the beam 12 is lowered into the through chamber of the upper support element 111 until it reaches the enlarged middle section 113. As the aperture of the enlarged middle section 113 is greater than the beam 12's width, the beam 12 is turned so that its width dimension faces the lower section 114 and as such falls into the lower section 114.

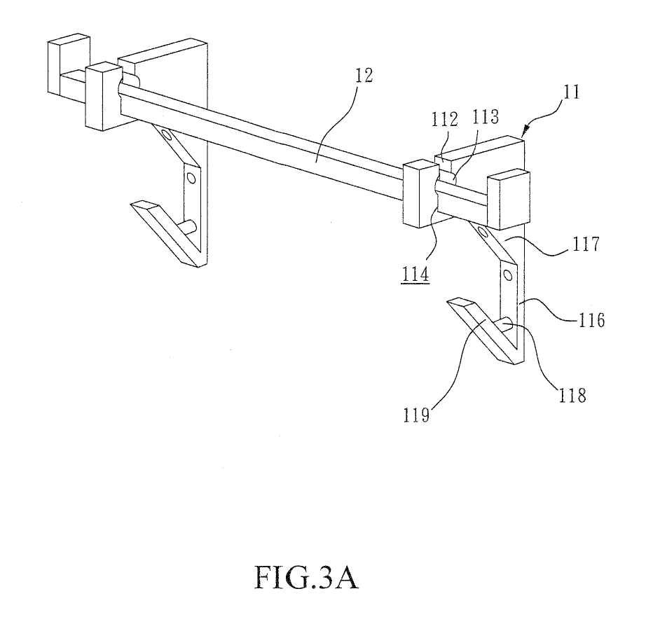

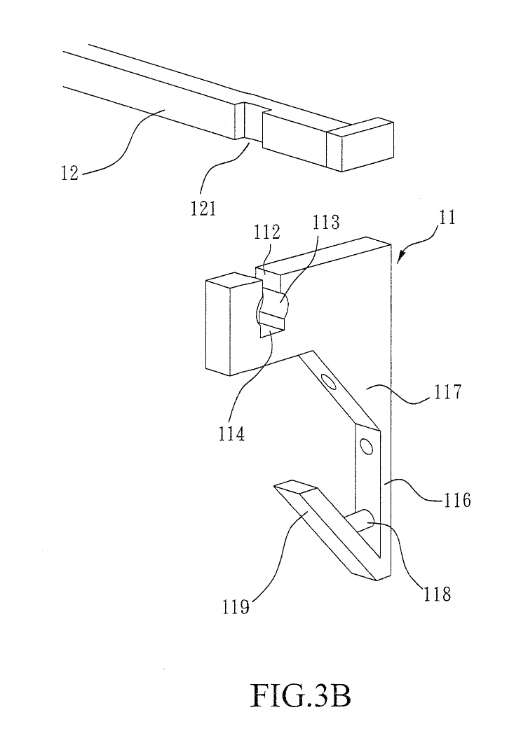

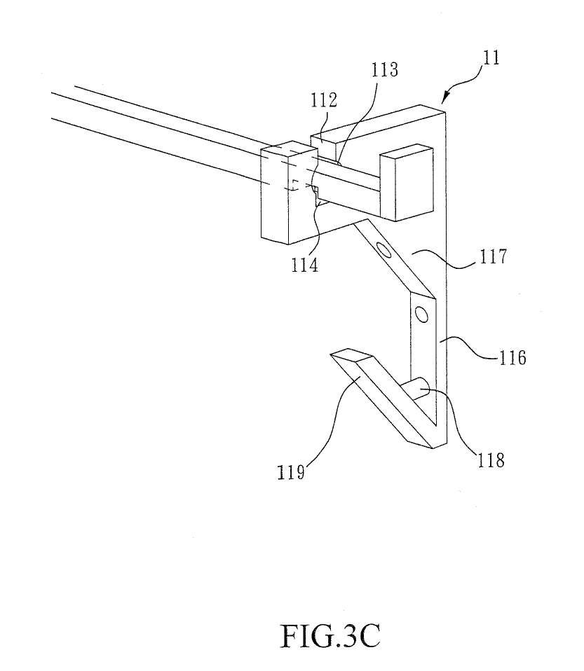

According to a second embodiment of the present invention shown in FIGS. 3A˜3C, a lower face of the beam 12 is configured with a notch 121 whose length matches that of the lower section 114. As such, when the beam 12 is assembled to the column members 11, the beam 12 is tightly and reliably positioned on the column members 11 by the notch 121's engaging the lower section 114.

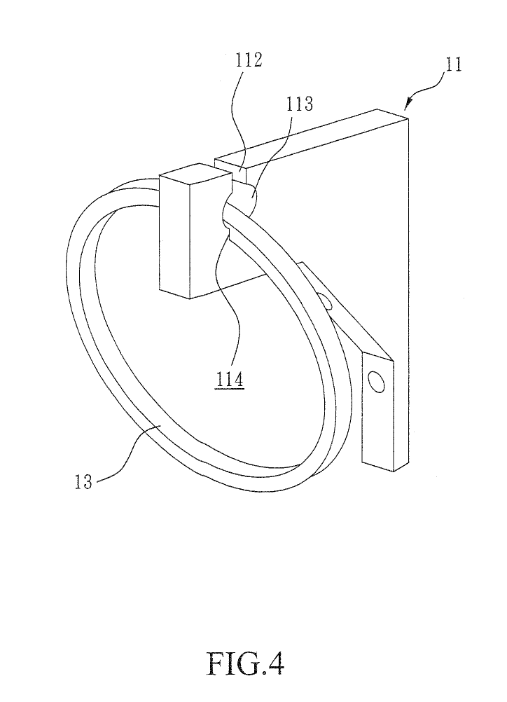

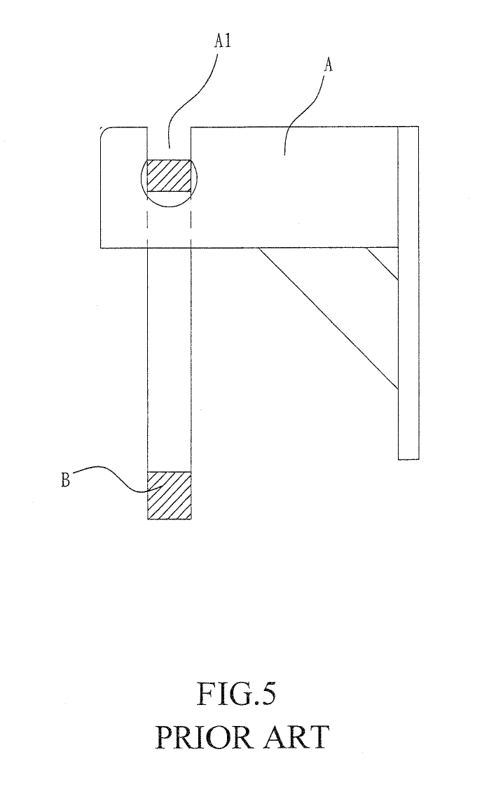

According to a third embodiment of the present invention shown in FIG. 4, the beam 12 of the previous embodiments is replaced by a ring 13 whose cross-section's length matches the width of the lower section 114. Similarly, the ring 13 is held laterally so that the smaller thickness of the ring 13 and then is lowered into the through chamber of the upper support element 111 until it reaches the enlarged middle section 113. The ring 13 is then turned and falls into the lower section 114.

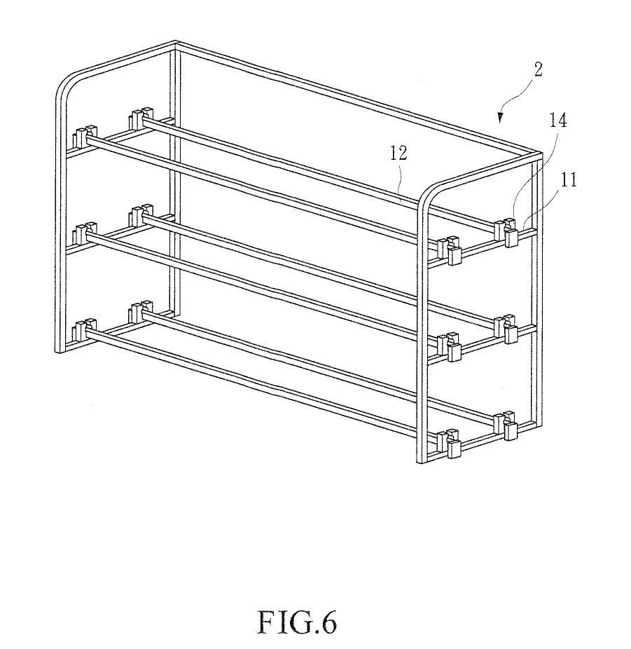

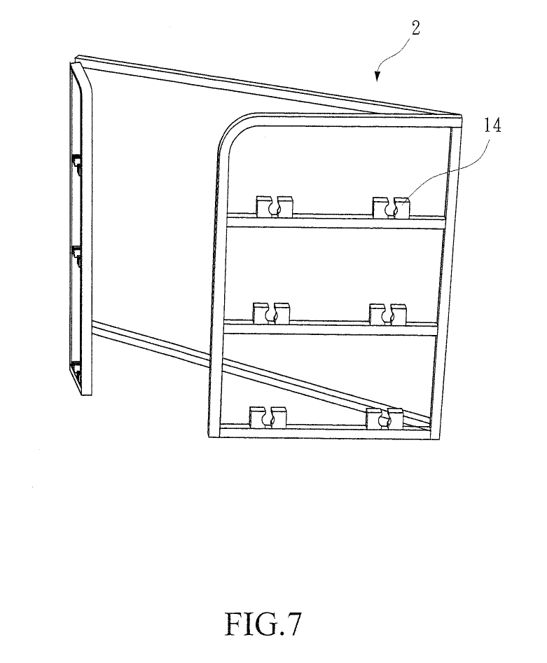

As shown in FIGS. 6 and 7, a rack 2 according to a fourth embodiment of the present invention has multiple sets of support elements from the column members 11. Additionally, the support elements of the column members 11 are further extended and configured with a number of blocks 14. Each block 14 is configured with the aforementioned through chamber. The column members 11 can be folded or unfolded. When the column members 11 are unfolded and the beams 12 are installed, the rack 2 is firmly and reliably expanded as shown in FIG. 6. After the beams 2 are removed, the column members 11 can be folded as shown in FIG. 7.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A rack, comprising:
a beam; and
a supporting member configured to support said beam, wherein an opening in said supporting member is configured to accommodate an insertion portion of said beam, wherein said insertion portion has a cross section with a first edge and a second edge longer than said first edge, wherein said opening has an upper width greater than said first edge and less than said second width, a middle width greater than said upper width and said second edge and a bottom width greater than said upper width and less than said middle width, wherein said opening has a planar bottom configured to have said second edge placed thereon.

2. The rack of claim 1, wherein a notch at a bottom side of said beam is configured to accommodate said supporting member.

3. The rack of claim 1, wherein said supporting element comprises an lower element and an upper element on said lower element, wherein said opening passes through said upper element and ends at said lower element.

4. The rack of claim 3, wherein said supporting element further comprises a pin joining said lower element and said upper element and passing through said lower element.

5. The rack of claim 3, wherein said supporting element further comprises a base element extending in a vertical direction and joining an end of said lower element extending in a lateral direction and an end of said upper element extending in said lateral direction.

6. The rack of claim 5, wherein said supporting element further comprises a hook at a bottom of said base element.

7. The rack of claim 5, wherein said supporting element further comprises a reinforcement element contacting said lower element and said base element.
